(19) United States
(12) Patent Application Publication
(10) Pub. No.: US 2011/0316284 A1
(43) Pub. Date: Dec. 29, 2011

(54) Power Density Enhancement Apparatus For Wind Turbines

(76) Inventor: Mehrzad Tabatabaian, Coquitiam (CA)

(21) Appl. No.: 12/677,950

(22) PCT Filed: Sep. 12, 2008
(86) PCT No.: PCT/CA08/01637

§ 371 Date: Sep. 13, 2011

Related U.S. Application Data
(60) Provisional application No. 60/971,712, filed on Sep. 12, 2007.

(51) Int. Cl. F03D 9/00; F03D 1/04

(52) U.S. Cl. 290/55; 415/202

(57) ABSTRACT

A wind deflector apparatus configured for increasing the velocity of an airstream flowing therethrough. The wind deflector apparatus comprises a hybrid conduit with one end comprising a first conduit having a distal end configured for receiving an airstream. The other end of the hybrid conduit comprises a pair of conduits wherein the distal ends of the pair of conduits are configured for releasing the airstream. The proximal ends of the pair of conduits depend together and are sealingly conjoined to the proximal end of the first conduit. The diameter of the distal end of first conduit is greater than the combined diameters of the distal ends of the pair of conduits. The wind deflector apparatus is communicable with wind tunnels and with wind-powered turbine generators. The wind deflector apparatus may have one or more wind-powered turbine generators installed in at least one of the conduits.

### FIELD OF THE INVENTION

This invention relates to electrical power generation by wind-powered turbine systems. More particularly, this invention relates to apparatus, systems and methods for increasing electrical power generation by small wind-powered turbine systems.

### BACKGROUND OF THE INVENTION

In recent years, energy supply, security and environmental concerns have encouraged researchers and industries to look more seriously into renewable energy sources. Among these resources, wind power generation systems have become a major part of renewable energy technologies. Various configurations for wind turbine technologies, wind power farms, and for integrating wind-generated electrical power into distribution power grids are known. The cost of wind-generated electricity in large-scale wind farm installations is economically viable when compared to existing hydropower or fossil fuel energy sources.

The electrical power-generating potential of a freely flowing stream of air is proportional to the cube of wind velocity magnitude and can be determined by

$$P = \frac{1}{2} ρ {AV}^{3} \qquad ( 1 )$$

where, ρ is air density (kg/m3), A cross-sectional area (m2) and V the mean wind velocity (m/s). This nonlinear proportionality has encouraged the researchers to look for ways to enhance the velocity and hence the power output of a wind turbine. For large-wind velocity (>4 m/s) areas, sufficient power output achieved by designs that fall under the category of diffuser augmented wind turbines (DAWT) or by using long blades for the turbines to capture more swept area. However, economics, manufacturing and assembly complexities have prevented the DAWT technology from becoming widely adopted. New wind power technologies and R&D activities are required to extract power from small-wind areas. Small-wind turbines, new materials, turbine reliability and efficiency, computer simulation are among the list of challenging research issues that require further study.

### SUMMARY OF THE INVENTION

The exemplary embodiments or the present invention are directed to wind deflector apparatus configured for controllably cooperating with wind-tunnel power generating installations, to natural windstream power-generating installations comprising said wind deflector apparatus, and to methods for generating electrical power from all windstreams power-generating installations comprising said wind deflector apparatus.

An exemplary embodiment of the present invention is directed to a wind deflector apparatus comprising an inlet conduit conjoined to and communicating with at least two outlet conduits. The at least two outlet conduits are each provided with an outlet port. The two outlet ports are configured for sealable engagement with a downstream portion of a wind tunnel containing therein power-generating turbine.

According to one aspect, the inlet conduit of the wind deflector is provided with an inlet port that is sealably engagable with an upstream portion of a wind tunnel or natural wind stream.

According to another aspect, a power-generating turbine is installed inside the inlet conduit of the wind deflector.

According to another aspect, a power-generating turbine is installed inside at least one of the at least two outlet conduits of the wind deflector. It is suitable to install a power-generating turbine into each of the at least two outlet conduits of the wind deflector.

According to yet another aspect, a first power-generating turbine is installed inside the inlet conduit of the wind deflector, and a second power-generating turbine is installed inside at least one of the at least two outlet conduits of the wind deflector. It is suitable to install a second power-generating turbine into each of the at least two outlet conduits of the wind deflector.

According to a further aspect, the outlet conduits of the wind deflector are each provided with a helical channel extending therethrough. The helical channel may extend outward from the inner wall of the outlet conduit thereby providing a helical trough extending therethrough the outlet conduit. Alternatively, the helical channel may extend inward from the inner wall of the outlet conduit thereby providing a helical ridge extending therethrough the outlet conduit. An air stream flowing through such outlet conduits will be directed by the helical channels, to flow in a vortexing direction thereby collecting, channeling and concentrating the air stream along the sides of the outlet conduits thereby increasing the air pressure delivered to a turbine installed about the outlet port of the outlet conduit or alternatively, in the wind tunnel downstream to the outlet leg.

Another exemplary embodiment of the present invention is directed to a wind tunnel power-generating system comprising a wind tunnel, a controllably operable power-generating turbine mounted about the wind tunnel, and a wind deflector apparatus of the present invention cooperatively engaged with the wind tunnel upstream of the turbine. It is suitable to configure the wind tunnel power-generating system for mounting on an elevated surface as exemplified by building rooftops.

According to one aspect, the turbine is mounted inside the wind tunnel about downstream from the outlet ports of the wind deflector.

According to another aspect, the outlet ports of the wind deflector are sealably engaged to the inlet port of the wind tunnel.

According to another aspect, the outlet ports of the wind deflector are sealably engaged to a downstream portion of the wind tunnel situated upstream of the turbine, while the inlet port of the wind deflector is sealably engaged to an upstream portion of the wind tunnel.

According to yet another aspect, at least one power-generating turbine is mounted inside the wind deflector. In this configuration, it isn't necessary to mount an additional turbine inside or about the wind tunnel.

According to a further aspect, a controllably operable side-draft conduit is provided into the wind tunnel downstream of the wind deflector for providing additional airflow into and through the wind tunnel and wind deflector.

Additional exemplary embodiments of the present invention are directed to methods for controllably generating electrical power with the exemplary wind tunnel power-generating systems comprising a wind tunnel, a controllably operable power-generating turbine mounted about the wind tunnel, and a wind deflector apparatus of the present invention cooperatively engaged with the wind tunnel upstream of the turbine.

### BRIEF DESCRIPTION OF THE DRAWINGS

The present invention will be described in conjunction with reference to the following drawings, in which:

FIG. 1 is a side view showing a wind-powered turbine generator assembly comprising an exemplary wind deflector of the present invention;

FIG. 2 is a perspective view of the wind deflector shown in FIG. 1;

FIG. 3 is a three-dimensional schematic representation of the velocity (longitudinal) and pressure (vertical) distributions of air flowing inside the exemplary wind deflector shown in FIGS. 1 and 2;

FIG. 4 is a first perspective view showing an early stage in the construction of an exemplary form useful for production of the wind deflector shown in FIG. 2;

FIG. 5 is a second perspective view showing a later stage in the construction of the exemplary form shown in FIG. 4;

FIG. 6 is a perspective view of the finished exemplary form from FIGS. 4 and 5;

FIG. 7 is a perspective view of the exemplary wind deflector from FIG. 2, shown from its inlet end;

FIG. 8 is a perspective view showing exemplary handles provided for adjusting control vanes installed in the wind tunnel main duct and a side-draft duct downstream of another exemplary wind deflector;

FIG. 9 is a perspective end view showing an exemplary control vane installed inside the wind tunnel duct downstream from of the exemplary wind deflector shown in FIG. 8;

FIG. 10 is a perspective view showing one exemplary embodiment for a blade-powered wind turbine installed into the entrance/inlet of one of the wind tunnel ducts of the exemplary wind deflector shown in FIG. 2;

FIG. 11 is a perspective view showing another exemplary embodiment for a blade-powered wind turbine installed into the entrance/inlet port of one of the wind tunnel ducts of the exemplary deflector shown in FIG. 2;

FIG. 12 is a chart showing the power-generating curves measured at the inlet end of the exemplary power density enhancement apparatus shown in FIG. 11; and

FIG. 13 is a chart showing the power-generating curves measured at the outlet ends of the exemplary power density enhancement apparatus shown in FIG. 11.

### DETAILED DESCRIPTION OF THE INVENTION

Exemplary embodiments of the present invention relate to power-generating systems comprising an air intake for receiving air streams, a wind tunnel for delivering the air streams to a wind-powered generator, and a wind deflector apparatus for increasing the velocity of air streams flowing into and/or through the wind tunnel prior to deliver to the wind-powered generator. Other exemplary embodiments related to wind deflector apparatuses configured for increasing the velocity of air streams flowing into and/or through wind tunnels.

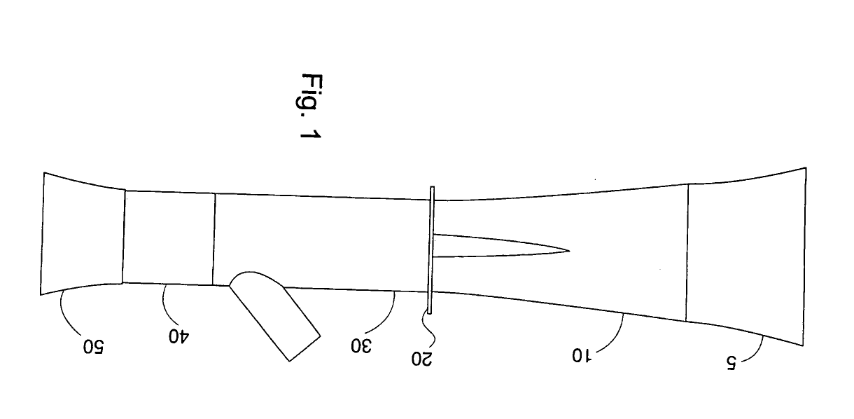

An exemplary power-generating system according to the present invention is shown in FIG. 1 and comprises a wind deflector apparatus 10 connected by a manifold 20 to a wind tunnel 30, which in turn is connected to a wind-powered generator 40. This exemplary system is provided with an optional air stream capturing port 5 at the air intake end of the system and an optional exhaust pipe 50 attached to the air outlet end of the power generator 40.

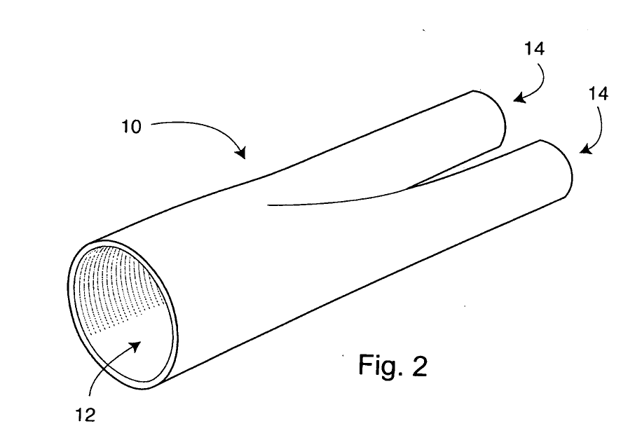

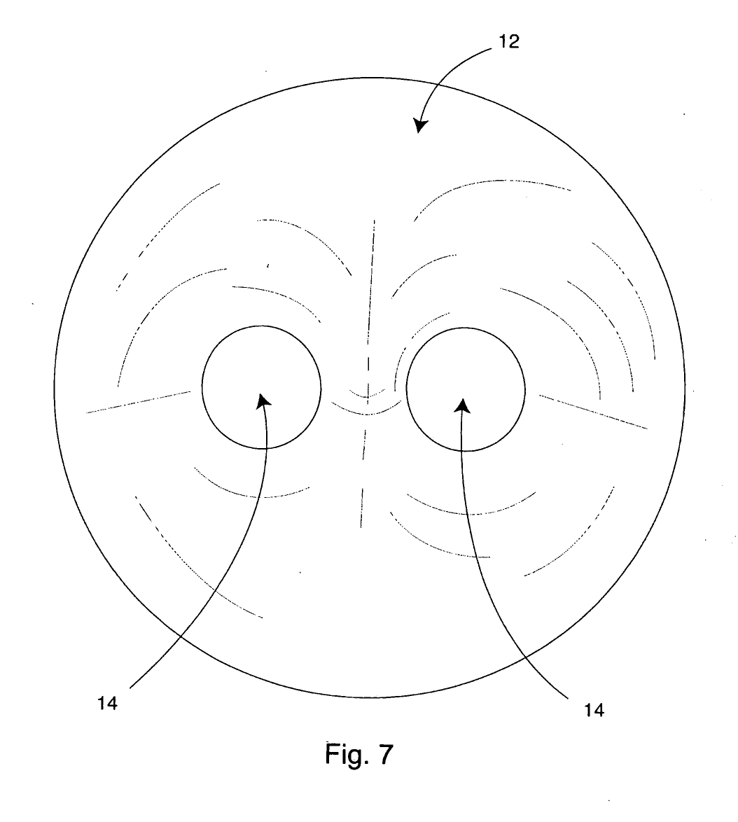

The exemplary wind deflector apparatus 10 is shown in FIGS. 2 and 7, and generally comprises an elongate hybrid conduit with one end comprising a first conduit having a distal end 12 configured for receiving therein an inflowing stream of air. The opposite end of the hybrid conduit comprises a pair of matched conduits wherein the distal end of each conduit 14 is configured for releasing therefrom an outflowing stream of air. The proximal ends of the pair of matched conduits depend together 15 and are sealably conjoined with the proximal end of the first conduit. The inlet 12 diameter of the first conduit receiving the inflowing air is larger than the outlet 14 diameters of the pair of matched conduits.

### Example 1

An exemplary wind deflector apparatus according to one bodiment of the present invention, was constructed using fibreglass molding techniques and materials to produce a hybrid conduit structure comprising a one-bore inlet end and a two-leg outlet end.

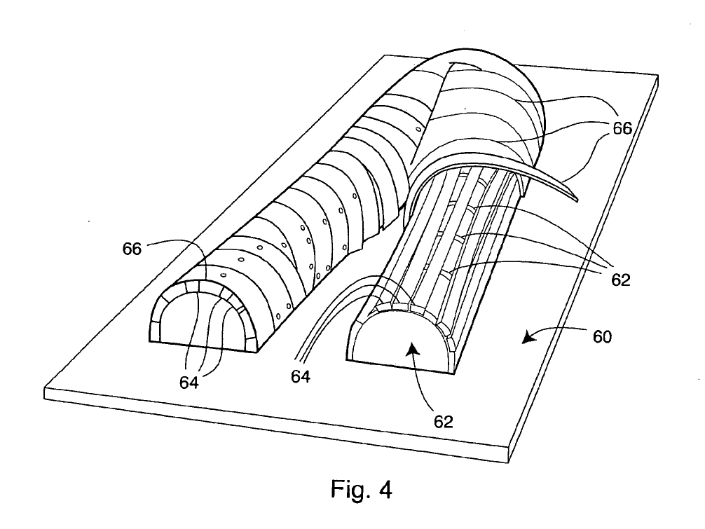

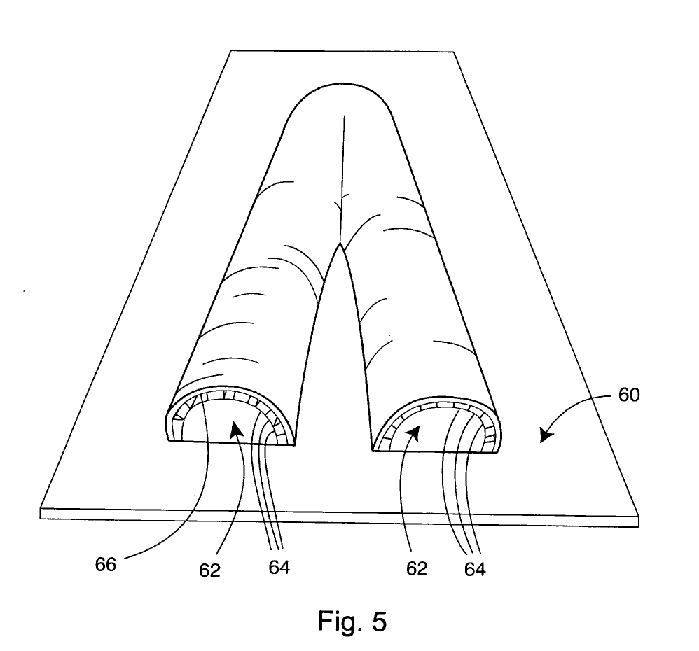

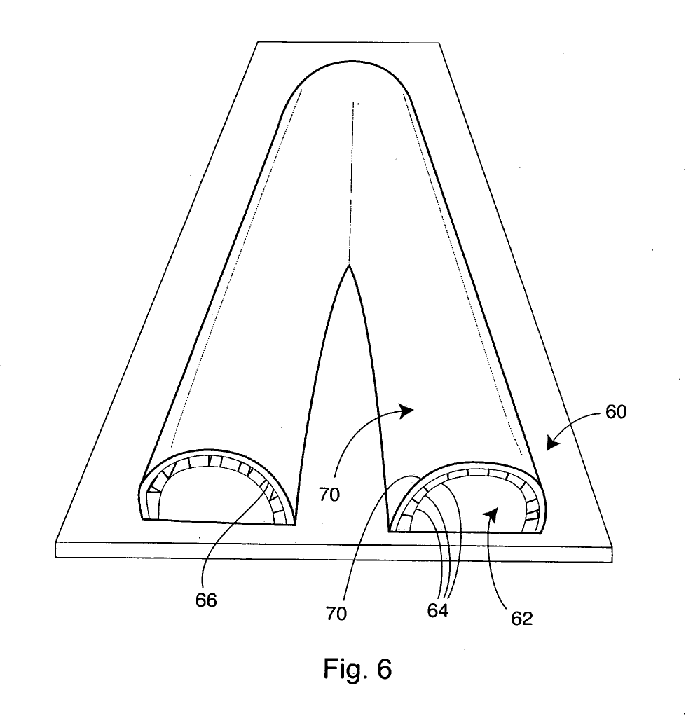

As shown in FIGS. 4 and 5, a plurality of semi-circular plywood sections 62 were cut to shape and then securely mounted to a baseboard 60 at selected spaced-apart positions. A plurality of stringers 64 spanning the length of the space-apart plurality of semi-circular plywood sections 62 to create a platform for overlaying with a plurality of ribberized plywood skin pieces 66. The rubber plywood skin pieces 66 were applied in two layers at 90 degrees in opposite directions to fully cover the form. Small gaps and holes were filled and sanded smooth, followed by two layers of latex paint, and then finished with a layer of a parting wax to enable the fibreglass molding 70 (FIG. 6) to be removed easily from the form. Two identical ½ molds were built and joined together with fibreglass tape and resin to produce a finished wind deflector apparatus such as that shown in FIG. 2. The diameter of the air inlet end 12 was 400 mm while the diameters of the air outlet ends were 160 mm. Fibreglass materials were chosen for their ease of workability during preparation, construction and installation. However, those skilled in these arts will appreciate that many different types of materials e.g., metals, composites, plastics, resins, carbon fibres and the like, are suitable for producting the wind deflector apparatuses disclosed herein.

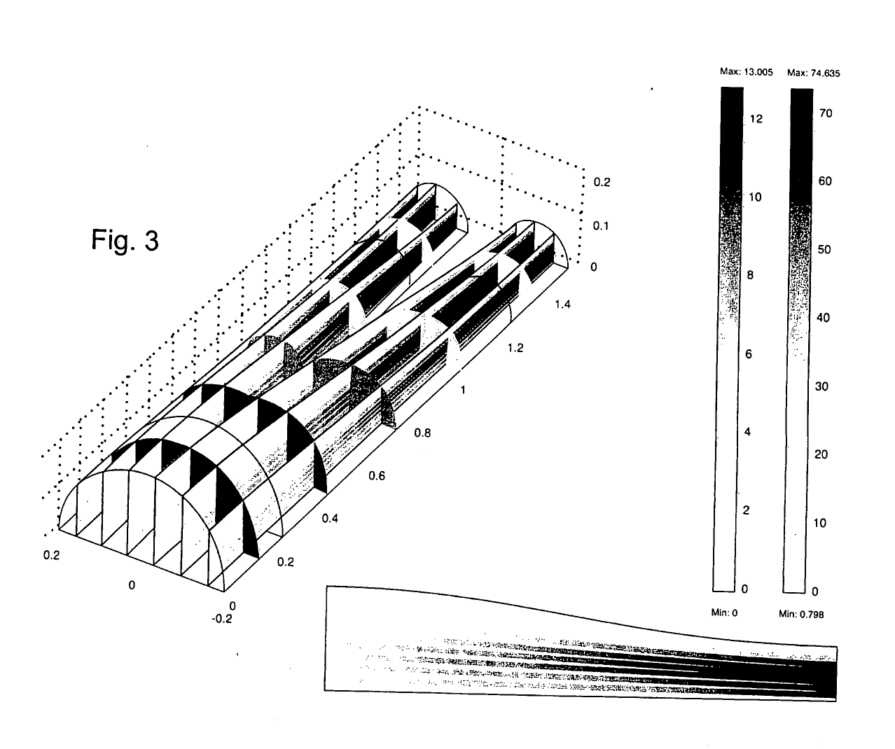

The velocity field and the pressure distribution inside the wind deflector apparatus constructed as disclosed herein were calculated by solving the Navier-Stokes equations using the COMSOL® Multiphysics® CFD package (COMSOL and Multiphysics are registered trademarks of the Comsol AB Corp., Stockholm, Sweden). These results are shown in FIG. 3. The CFD results of the models were used to optimize the dimensions of the deflector for having fully-developed flow and even flow distribution through the two outlets. Using the model, we calculated the average velocity at the output of the deflector to be 9.68 m/s for an input value of 3.17 m/s. The experimental results of 9.88 m/s are shown in Table 1 and explained in section 5 validate the calculated values of the model. Several design iterations were carried out to finalize these details and dimensions.

TABLE 1

| | | | | | | | Voltage | | Voltage | | | | | |
|---|---|---|---|---|---|---|---|---|---|---|---|---|---|---|
| | Velocity at inlet of the | | | Velocity at | | | across | | across | | Electrical | | | |
| | deflector (m/s) | | | outlet of the | | | resistance/ | | turbine/ | | current/I | | Power/Pₘₐₓ | |
| Case | measured/ | Actual/ | | deflector (m/s) | | | V_{R} (Volt) | | V_{oc} (Volt) | | (Amp) | | (mW) | |
| # | Vₘ | Vₐ | Avg./V | measured | actual | Avg. | inlet | outlet | inlet | outlet | inlet | outlet | inlet | outlet |
| 1 | 6.5 | 6.33 | 3.17 | 20.2 | 19.76 | 9.88 | 0.72 | 3.75 | 1.17 | 4.9 | 0.072 | 0.375 | 55 | 1957 |
| 2 | 7 | 6.82 | 3.41 | 21.7 | 21.23 | 10.61 | 0.91 | 3.95 | 1.35 | 5.2 | 0.091 | 0.395 | 94 | 2136 |
| 3 | 7.3 | 7.11 | 3.56 | 23.3 | 22.79 | 11.4 | 0.92 | 4.05 | 1.4 | 5.39 | 0.092 | 0.405 | 94 | 2195 |
| 4 | 7.5 | 7.31 | 3.65 | 24.4 | 23.87 | 11.93 | 1.09 | 4.38 | 1.52 | 5.69 | 0.109 | 0.438 | 146 | 2706 |
| 5 | 8.1 | 7.89 | 3.95 | 25.2 | 24.65 | 12.33 | 1.11 | 4.45 | 1.55 | 5.85 | 0.111 | 0.445 | 152 | 2719 |
| 6 | 8.3 | 8.09 | 4.04 | 25.9 | 25.34 | 12.67 | 1.19 | 4.65 | 1.6 | 5.95 | 0.119 | 0.465 | 186 | 3166 |
| 7 | 8.8 | 8.57 | 4.29 | 26.2 | 25.63 | 12.81 | 1.22 | 4.75 | 1.65 | 6.05 | 0.122 | 0.475 | 193 | 3343 |

### Example 2

An exemplary power-generating system according to the present invention was shown in FIG. 1 and comprised the wind deflector apparatus 10 constructed as described in Example 1. The wind deflector apparatus was connected by a manifold 20 to a wind tunnel 30, which in turn is connected to a wind-powered generator 40. A port 5 configured to capture and funnel air streams was attached to the inlet end 12 of the wind deflector apparatus 10. An exhaust pipe 50 was attached to the air outlet end of the power generator 40.

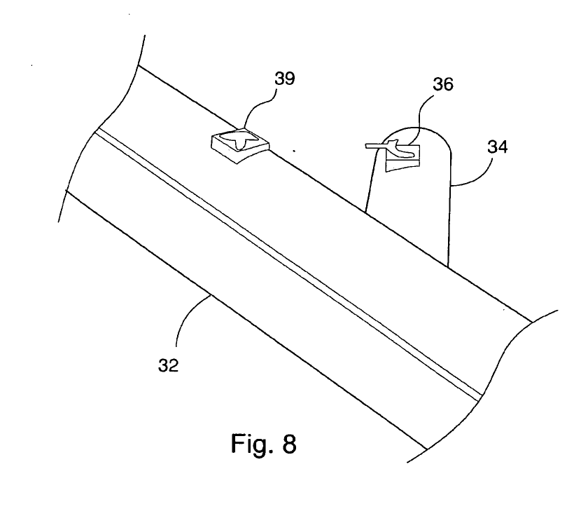

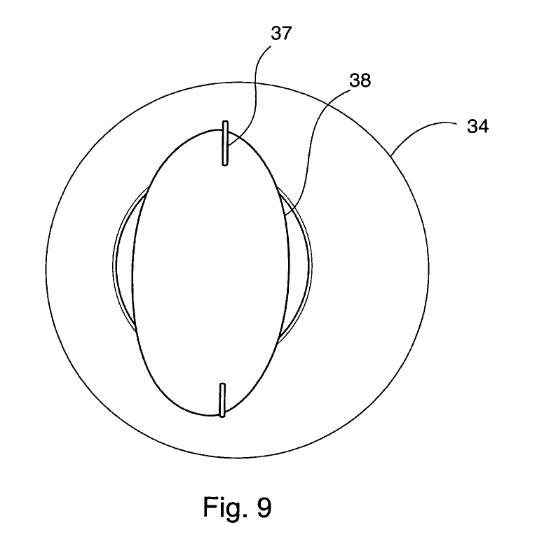

The wind tunnel 30 (exemplified in FIGS. 1 and 8) was a galvanized steel cylindrical duct 7000-mm long with a 400-mm diameter cross section, and contained a side-draft pipe section 34. The wind tunnel 30 contained a suction motor (not shown) supplied by Hubbell Inc. Corp. (Orange, Conn., USA) equipped with a Circuit-Lock® manual motor controller (Circuit-Lock is a registered trademark of Hubbell Inc. Corp.). The air current velocity inside the wind tunnel 30 was controlled by a first vane 39 mounted inside the tunnel 30, and a second vane 36 mounted inside the side-draft pipe 34. The vanes comprised a flap 38 mounted on a shaft 37 (FIG. 9). The first vane 39 mounted in the tunnel 30 was manipulate do to control the air flow rate through the tunnel, and thus, the velocity magnitude. We kept the vane in the side duct closed throughout the experiment. The vanes were adjusted by two handles mounted on the top of the tunnel, as shown in FIG. 8.

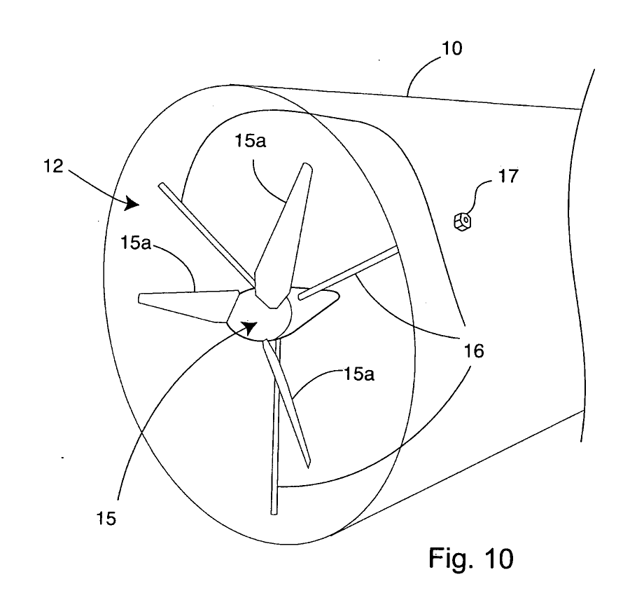

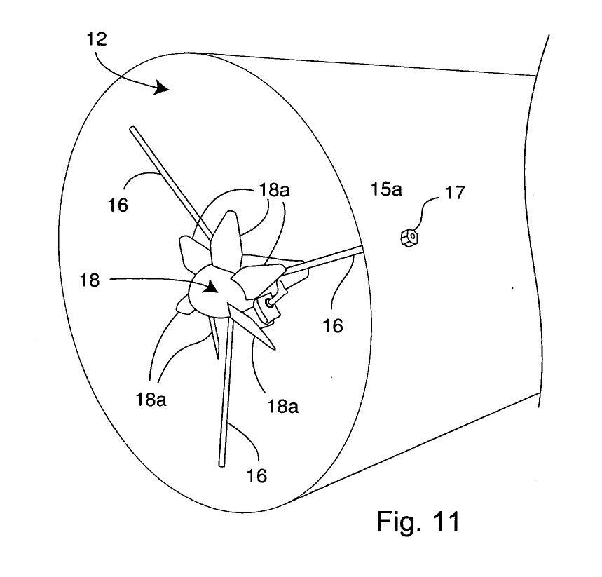

Two micro-wind turbine kits were purchased from the Alternative Technologies Association (ATA; Melbourne, Australia) for installation at the air intake ends of the wind tunnel 30. These turbines were selected mainly for their sizes and rotor assemblies, which enabled configuration of different blade profiles or alternatively different number of blades on the turbines as exemplified in FIGS. 10 and 11. The turbine kits come with three blades (FIG. 10), but the rotor hubs allow six blades to be mounted on each hub. The blades supplied with the kits with a set of smaller blades of our own design and fabrication (FIG. 11). The material used for our blades was polyester-vinyl laminate with a thickness of 0.62 mm. The smaller blades, when mounted on the turbine, have a diameter of 140 mm, which fit into the outlet of the deflector (diameter 160 mm). The original motor in the turbine was an AC motor attached to an electronic circuit, including a capacitor, resistors and diodes. The motor was replaced the motor with a 4.8 volt DC motor (Barber-Colman Model No. FYQM 62800-1, supplied by Eurotherm Inc., Leesburg, Va., USA) and the electronic circuit was by-passed to enable direct measurement of the DC power output by the turbine.

The velocity, flow rate and the temperature were measured with a TSI®Velocicalc® 8346 anemometer (TSI and Velocicalc are registered trademarks of TSI Inc., Shoreview, Minn., USA). This device is calibrated to measure the velocity at a standard temperature (21.1° C.). The actual velocity Va (m/s), which takes into account the ambient pressure Pm (kPa) and temperature Tm (degrees Celsius) can be calculated by using Eq. (2)

$${V}_{a} = {V}_{m} [ \frac{273 + {T}_{m}}{273 + 21.1} ] \frac{101.4}{{P}_{m}} \qquad ( 2 )$$

where Vₘ(m/s) is the measured velocity. The voltage and electrical current of the turbine were measured using a standard FLUKE® Model No. 73III multi-meter (FLUKE is a registered trademark of the Fluke Corp., Everett, Wash., USA).

The experimental set-up is shown in FIG. 11. The deflector was mounted on the wind tunnel with its inlet at 4010 mm and its outlet 2660 mm from the suction motor intake location. The distance from the intake of the wind tunnel to the inlet of the deflector was 3850 mm. This distance was sufficient for flow to become fully developed before reaching the turbine and the anemometer. The turbine was installed inside the deflector.

### Example 3

For measurements of the wind current velocity, the wind deflector apparatus was mounted to the wind tunnel without the turbine installations. The velocity magnitude was measured at the centre of the duct using the anemometer. The measurements for seven cases, both at the inlet and the outlet locations of the deflector. The flow rate for each case was controlled by adjusting the vane of the wind tunnel. The results are shown in Table 1.

After shutting down the suction motor, the wind deflector apparatus was removed, and the 3-blade turbine was installed at the inlet end of the wind deflector apparatus. The center of the turbine hub was adjusted to be at the center-line of the wind deflector, where the free-stream velocity magnitudes were measured. Two wires were connected to the motor and passed through a small hole drilled in the deflector. Then the wind deflector with the 3-blade turbine installed at the inlet end, was re-installed into the wind tunnel duct 30. The vane control was adjusted to be at the same locations as for velocity measurements cases. For each case, the open circuit voltage (V_{OC}) of the turbine was measured, and the current generated in a circuit connected to the turbine, which included a 10-Ohm resistor in series with the motor armature, was measured. The voltage across the resistance (V_{R}), was measured in order to calculate the current (I) generated by the turbine. The measurements were repeated for all seven cases. The results are shown in Table 1.

To measure the performance of the turbine at the outlet end of the wind deflector, the suction motor was shut down, the 3-blade turbine was removed from the inlet end, and then re-installed close to the end of one of the wind deflector outlets. The other outlet was left unobstructed in order to measure the power produced by the turbine in one of the outlets. Optionally, another turbine could be installed in the other outlet. The set of desired quantities (V_{OC} and V_{R}) were measured for all seven cases with the predefined flow rates. The results obtained are shown in Table 1.

It was assumed that the average air velocity in the wind deflector apparatus is half of that of its maximum value, which occurs at the centerline. The measured velocity values were used to calculate the average values. These average values were converted to their actual values using Eq. (2). The measured ambient temperature was used for the temperature values (Tₘ). The ambient pressure was assumed to be 101.4 kPa because the tests were performed close to sea level. The objective for each measurement case was to calculate the maximum power (Pmax) out of the turbine, or the DC motor. An algorithm was developed to exemplify the maximum power of an arbitrary resistance. The result is given in Eq. (3):

$${P}_{max} \frac{{V}_{OC}^{2}}{4 r} \qquad ( 3 )$$

Where r is the DC motor internal resistance, given by Eq. (4):

$$\begin{matrix}r = \frac{{V}_{OC} - IR}{I} & ( 4 ) \\ I = \frac{{V}_{R}}{R} & ( 5 )\end{matrix}$$

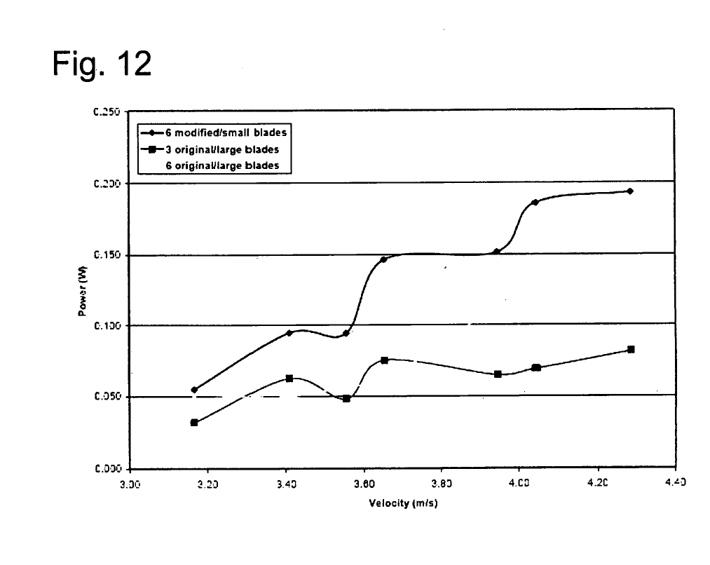

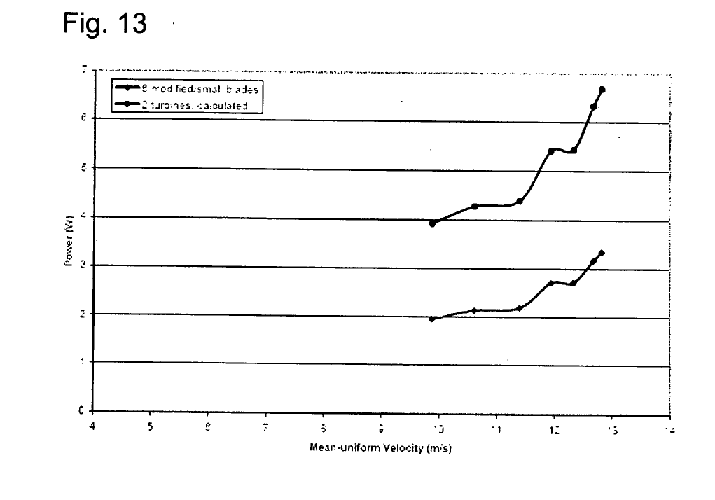

The values of maximum power are given in Table 1. The main objective of this study was to demonstrate the power density increase of the turbine and the velocity enhancement of the air stream due to the deflector. For this purpose, the values of maximum power were graphed versus the undisturbed actual average wind velocity inside the deflector. This curve is referred to as the power curve for a turbine. FIG. 12 shows the results of maximum power curves when the turbine is installed at the inlet, and FIG. 13 shows the maximum power curves when the turbine is installed in one outlet of the deflector. For the case with six small blades, the measured power of the turbine installed at the inlet, ranged from 55 to 193 mW with an average velocity of 3.17 to 4.29 m/s, respectively. The corresponding measured power at the outlet ranged from 1957 to 3343 mW with an average velocity of 9.88 to 12.81 m/s, respectively. These measured values show that the deflector is capable of enhancing the average velocity by a factor of 3 and maximum power by a factor of 17. In some cases, the enhancement factor for the power reached as high as 20. FIG. 13 also shows the results obtained for the turbine with 3 and 6 original blades. Since these blades were too long (2×140 mm) to fit in the outlet of the deflector, they could only be fitted and the power output measured at the inlet. As seen from FIG. 13, the curves for 3 and 6 original blades, show lower power values than that of the 6-modified blades. This is due to the fact that modified blades are more rigid than the original blades. In FIG. 13, the power curves for two turbines in the outlets of the wind deflector apparatus are shown. These values were calculated from the measured power output of one turbine. In practice, there can be several turbines installed in series in each outlet to produce more power.

The disclosures herein provide an exemplary wind deflector apparatus suitable for enhancing power density produced by a wind turbine, and in particular, for wind turbines configured for use with wind tunnels. The analyses of the data generated with exemplary wind deflector apparatus in cooperative communication with an exemplary turbine mounted into an exemplary wind tunnel, demonstrate that the wind deflector apparatus enhances the velocity of air streams approaching the turbine thereby increasing the turbine's electrical power output. The results with the present exemplary system show the air speed velocity is increased by a factor of about 3, and that the power output e was increased by a factor of about 20. The performance characteristics of the wind deflector apparatus make it suitable for low-wind velocity (<4 m/s) areas exemplified by the rooftops of buildings. The exemplary apparatus and systems disclosed herein can be optionally configured to enable installation of a plurality of the wind deflectors in series in a wind tunnel installation. It is within the scope of this invention to install a turbine at the inlet end of the wind deflector, in one or alternatively both outlet ends of the wind deflector, and/or concurrently at the inlet and outlet ends of the wind deflector. It is also within the scope of the present invention to provide the wind deflector with a plurality, i.e., more than 2 outlet legs. It is suitable to provide at least one turbine in an outlet leg and optionally, to provide at least two turbines in a series in an outlet leg. Furthermore, at least one of the outlet legs maybe optionally provided with a curvature, i.e., a bend to provide an acceleration of an air stream passing therethrough. It is also within the scope of this invention to provide a helical channel molded into the sides of one or more of the outlet legs for the purpose of collecting, channeling and concentrating the air stream along the sides of the outlet legs thereby providing additional air pressure delivered to a turbine installed about the outlet port of the outlet leg or alternatively, in the wind tunnel downstream to the outlet leg. It is also within the scope of the present invention to provide a rotatable air stream capture device mounted about the air inlet end of the wind deflector for directing multi-directional air stream into the wind deflector. Alternatively, it is also within the scope of the present invention to provide at least one airstream-feeder device anterior to the inlet port of the wind deflector, wherein the air stream-feeder device is configured to collect a free-flowing air stream and re-direct it into the inlet port of the wind deflector. It is suitable to provide a plurality of air stream-feeder devices about the inlet port of the wind deflector for collecting air streams flowing about in different directions and re-directing them into the inlet port of the wind deflector. It is also suitable to configure air stream-feeder devices for manipulable and controllable rotation about an axis to enable maximal capture, collection and re-direction of a free-flowing air stream into the inlet port of the wind deflector. In the event that a rotatable air stream capture device is provided about the air inlet end of the wind deflector, it is suitable to mount the wind deflector at the air inlet end of the wind tunnel. Those skilled in these arts will understand that the various design and installation configurations disclosed herein for the wind deflector of the present invention with enable mitigation of noise and vibrations generated by turbines.

While this invention has been described with respect to the exemplary embodiments, it is to be understood that various alterations and modifications can be made to components and the applications of the wind deflector apparatus within the scope of this invention, which are limited only by the scope of the appended claims.

1. A wind deflector apparatus configured for increasing the velocity of an airstream flowing therethrough, the wind deflector apparatus comprising a hybrid conduit with one end comprising a first conduit having a distal end configured for receiving therein an airstream, and the other end comprising a pair of conduits wherein the distal ends of the pair of conduits are configured for releasing therefrom said airstream, the proximal ends of the pair of conduits depending together and sealingly conjoined to the proximal end of the first conduit, wherein the diameter of the distal end of first conduit is greater than the combined diameters of the distal ends of the pair of conduits.

2. A wind deflector apparatus according to claim 1, wherein the pair of conduits is a matched pair of conduits.

3. A wind deflector apparatus according to claim 1, wherein at least one of said pair of conduits is provided with a helical channel extending therethrough.

4. A wind deflector apparatus according to claim 1, additionally provided with an air stream-feeder device anterior to the distal end, wherein the airstream-feeder device is configured for collecting a free-flowing air stream and re-directing said air stream into the distal end.

5. A wind deflector apparatus according to claim 1, wherein the distal ends of the pair of conduits are sealingly engaged with a manifold, said manifold configured for sealable engagement with one of a wind tunnel and an air intake cooperating with a wind-powered turbine.

6. A wind deflector apparatus according to claim 1, wherein the distal end of the first conduit is configured for sealable engagement with one of a wind tunnel and an air intake tube.

7. A wind deflector apparatus according to claim 1, wherein the first conduit is configured about its distal end to demountably engage therein at least one wind-powered turbine.

8. A wind deflector apparatus according to claim 7, said apparatus provided with at least one wind-powered turbine demountably engaged therein about the distal end of the first conduit.

9. A wind deflector apparatus according to claim 1, wherein at least one of the pair of conduits is configured about its distal end to demountably engage therein at least one wind-powered turbine.

10. A wind deflector apparatus according to claim 9, said apparatus provided with at least one wind-powered turbine demountably engaged therein about the distal end of one of said pair of conduits.

11. A wind-powered system for generating electricity, said system comprising:
a wind-powered turbine generator configured with an air intake;
a wind deflector apparatus comprising a hybrid conduit with one end comprising a first conduit having a distal end configured for receiving therein an airstream, and the other end comprising a pair of conduits wherein the distal ends of the pair of conduits are configured for releasing therefrom said airstream, the proximal ends of the pair of conduits depending together and sealingly conjoined to the proximal end of the first conduit, wherein the diameter of the distal end of first conduit is greater than the combined diameters of the distal ends of the pair of conduits; and
a manifold communicably interconnected with the distal ends of the pair of conduits, and the air intake of the turbine generator.

12. A wind-powered system according to claim 11, additionally provided with a wind tunnel interposed and communicably interconnected with said wind deflector apparatus and said turbine generator.

13. A wind-powered system according to claim 11, additionally provided with one of a wind tunnel and an air-collection port interconnected with the distal end of the first conduit of the wind deflector apparatus.

14. A wind-powered system according to claim 11, additionally provided with an air stream-feeder device anterior to the distal end, wherein the airstream-feeder device is configured for collecting a free-flowing air stream and re-directing said air stream into the distal end.

15. A wind-powered system according to claim 14, additionally provided with a wind tunnel interconnected with the distal end of the first conduit and the airstream feeder device.

16. A wind-powered system according to claim 11, wherein the distal end of the first conduit is configured for sealable engagement with one of a wind tunnel and an air intake tube.

17. A wind-powered system according to claim 11, wherein the first conduit is configured about its distal end to demountably engage therein at least one wind-powered turbine.

18. A wind-powered system according to claim 17, wherein said wind deflector apparatus is provided with at least one wind-powered turbine demountably engaged therein about the distal end of the first conduit.

19. A wind-powered system according to claim 11, wherein at least one of the pair of conduits of said wind deflector apparatus is configured about its distal end to demountably engage therein at least one wind-powered turbine.

20. A wind-powered system according to claim 19, said wind deflector apparatus is provided with at least one wind-powered turbine demountably engaged therein about the distal end of one of said pair of conduits.

21. A method for generating electrical power on elevated structural surfaces, the method comprising:
installing a wind-powered system for generating electricity according to claim 11 on a selected elevated structural surface;
controllably operating the wind-powered system to produce and transmit electrical power therefrom.

22. A method according to claim 21, wherein the selected elevated structural surface is a rooftop on a building.

23. A method according to claim 21, wherein the selected elevated structural surface is a vertical side surface of a building.

24. A method according to claim 21, wherein said transmitted electrical power is storable for controllably supplementing a power grid supply of electricity to said building.
